(19) United States
(12) Patent Application Publication
(10) Pub. No.: US 2025/0254368 A1
(43) Pub. Date: Aug. 7, 2025

(54) Location-Based Content Playout

(71) Applicant: Disney Enterprise, Inc., Burbank, CA (US)

(72) Inventors: Steven C. Eaton, Burbank, CA (US); John K. Lewis, Burbank, CA (US); Stuart Randle, Burbank, CA (US); Michael M. Gonterman, Burbank, CA (US); Marcus W. Ledet, Burbank, CA (US); Thomas Arthur, Burbank, CA (US); Ernie Martin, Burbank, CA (US); David Worrall, Clermont, FL (US); Jeffrey R. Schenck, Burbank, CA (US); Peter Stepniewicz, Burbank, CA (US); Greg G. Johnson, Burbank, CA (US)

(21) Appl. No.: 18/805,206

(22) Filed: Aug. 14, 2024

Related U.S. Application Data
(60) Provisional application No. 63/549,777, filed on Feb. 5, 2024.

(51) Int. Cl. H04N 21/214; H04N 21/239; H04N 21/258; H04N 21/414; H04N 21/6334

(52) U.S. Cl. CPC H04N 21/2143; H04N 21/2393; H04N 21/25816; H04N 21/41407; H04N 21/63345

(57) ABSTRACT

A system includes a computing platform having a hardware processor and a memory storing software code and a content delivery application deployable to multiple personal communication devices, as well as multiple directional antennas communicatively coupled to the computing platform. The hardware processor is configured to execute the software code to, transmit, using a first directional antenna of the multiple directional antennas, a content activation signal to a predetermined area within a venue, transmission of the content activation signal being limited to the predetermined area. The content activation signal causes content relevant to an event at the predetermined area to be played out by the content delivery application deployed to one of the multiple personal communication devices to a user of that personal communication device, only when that personal communication device is present in the predetermined area.

### RELATED APPLICATIONS

The present application claims the benefit of and priority to a pending U.S. Provisional Patent Application Ser. No. 63/549,777 filed on Feb. 5, 2024, and titled “Radio Frequency Enabled Accessibility Services,” which is hereby incorporated fully by reference into the present application.

### BACKGROUND

Content that provides accessibility services is used in many venues to help diverse audiences participate in and enjoy experiences that may otherwise be hampered by hearing difficulties, vision limitations, language barriers, and the like. One of the older forms of assistance is provided by hearing loop technology or Audio Frequency Induction Loop Systems (AFILS). With this technology, very high quality audio can be provided to equipped listener devices such as hearing aids. However, only one audio program can be provided in a venue, making AFILS less useful for providing translations. Also, although the signal provided by AFILS has low propagation distance, it is omnidirectional such that interference between content intended for different areas within a venue can occur.

As an alternative to the use of AFILS, a venue may broadcast a trigger signal across the entire venue that causes each individual assistive device present in the venue to playout pre-recorded audio. The pre-recorded audio can be unique to each assistive device such that one participant can receive a translation in one language, while a neighbor receives another language or differing content. The trigger signal may be broadcast using line of sight technology such as infrared (IR) signaling so that crosstalk between areas in a large venue is eliminated. This alternative approach can be augmented to provide streaming audio in addition to or as an alternative to pre-recorded audio and text, which may be useful for live performances where pre-recording is not practical. The streamed audio can be provided by FM broadcasting where individual users can manually tune or have their FM receivers automatically tuned to a particular channel having the content format they desire. However, unlike line of sight transmission methods, FM broadcasting can undesirably result in crosstalk interference between different areas of the venue.

In addition to crosstalk interference, another difficulty with existing approaches to providing accessibility services is that communications technologies such as IR, FM, and AFILS are not widely available on consumer devices such as smartphones. Consequently, those solutions require specialized equipment to operate and tend to be relatively expensive compared to consumer devices. However, despite the popularity and wide availability of consumer devices such as smartphones, those consumer devices typically employ omnidirectional antenna technology that is poorly suited for the specific needs of content providing accessibility services.

### BRIEF DESCRIPTION OF THE DRAWINGS

FIG. 1 shows a diagram depicting an exemplary system for providing location-based content playout, according to one implementation;

FIG. 2 shows a diagram depicting an exemplary system for providing location-based content playout, according to another implementation;

FIG. 3 shows a system for providing location-based content playout and a more detailed depiction of a personal communication device to which a content delivery application has been deployed, according to one implementation; and

FIG. 4 shows a flowchart presenting a method for providing location-based content playout, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for providing location-based content playout that address and overcome the deficiencies in the conventional art described above. The present location-based content playout solution advances the state-of-the-art by providing industry standard radio frequency (RF) communications equipment modified to include directional antenna technology in order to activate pre-recorded content stored on a personal communication device to which a delivery application has been deployed, or to transmit content to such a device using communication technologies commonly included in consumer electronics such as smartphones.

Content activation signals and content may be provided by directional antennas situated in a venue such as a theater, museum, or theme park, for example. The directional antennas used to provide the content activation signals, the content transmission signals, or both, advantageously produce narrow-beamed signals in a transmission pattern resembling the output of a spotlight, rather than a conventional omnidirectional broadcast. These directional transmission signals can be received and decoded by commercially available personal communication devices such as smartphones and wireless headphones that execute software to decode the content activation signals and the content, and playout the content to a user of the personal communication device. Multiple directional antennas capable of providing multiple digital channels of output advantageously enable users to select desired channels for their assistive needs.

In addition to, or as an alternative to providing accessibility services, the content provided using the systems and method described herein may be additional descriptive or interpretive material about a venue, technology used in the venue, features of a theme park attraction, or any other type of additional information desired by a user. This content may be provided at no cost, or may be provided as premium content to a user having purchased or otherwise obtained an entitlement to such premium content. Moreover, it is noted that the present location-based content playout solution can advantageously be implemented as automated systems and methods.

As used in the present application, the terms “automation,” “automated” and “automating” refer to systems and processes that do not require the participation of a human system operator. Although in some implementations, a human operator may review the performance of the systems and methods disclosed herein, that human involvement is optional. Thus, the methods described in the present application may be performed under the control of hardware processing components of the disclosed automated systems.

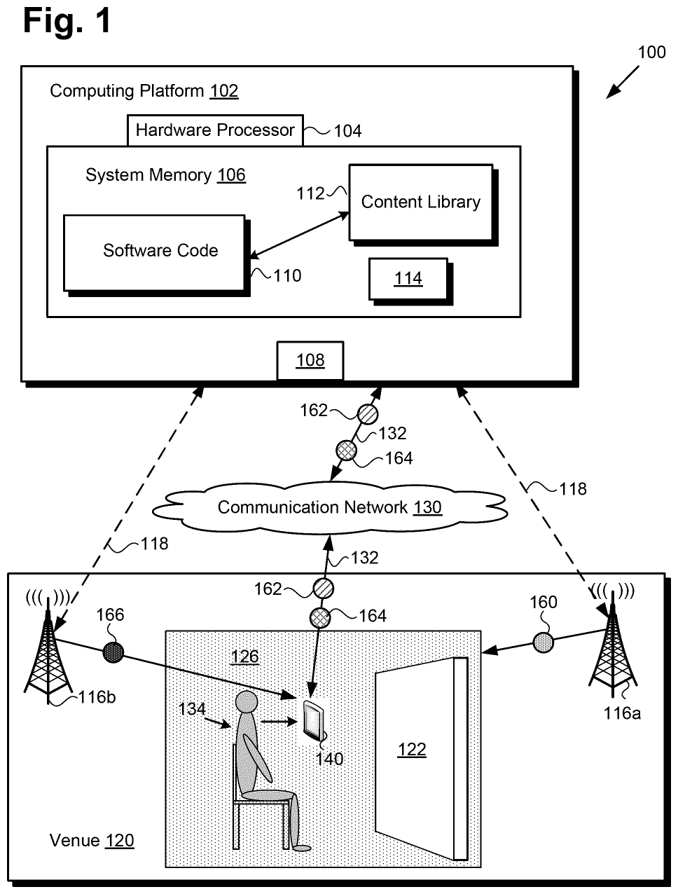

FIG. 1 shows a diagram of exemplary system 100 for providing location-based content playout, according to one implementation. System 100 includes computing platform 102 having hardware processor 104, system memory 106 implemented as a computer-readable non-transitory storage medium, and transceiver 108. According to the present exemplary implementation, system memory 106 stores software code 110, content library 112 and content delivery application 114 deployable to a variety of different types of personal communication devices, such as smartphones, tablet computers, wireless headphones, and augmented reality (AR) or virtual reality (VR) devices, for example. In addition, system 100 includes multiple directional antennas 116a and 116b communicatively coupled to computing platform 102 by communication links 118, which may be wired or wireless communication links.

As shown in FIG. 1, system 100 is implemented within a use environment including venue 120 in which directional antennas 116a and 116b are situated, and communication network 130. As further shown in FIG. 1, venue 120 includes user 134 in attendance at event 122 in the form of a movie screening, predetermined area 126 within venue 120, and personal communication device 140 utilized by user 134. Also shown in FIG. 1 are network links 132 of communication network 130 interactively connecting system 100 with personal communication device 140 of user 134, content activation signal 160 transmitted to predetermined area 126 of venue 120 by directional antenna 116a, optional request 162 for content received by system 100 from personal communication device 140 via communication network 130, optional authentication data 164 received by system 100 from personal communication device 140 via communication network 130, and content 166 optionally transmitted to personal communication device 140 by directional antenna 116b.

It is noted that although FIG. 1 depicts system 100 as including two directional antennas 116a and 116b, that representation is provided merely by way of example, and in other implementations, system 100 may include more than two directional antennas, such as dozens of directional antennas for example. Moreover, although the present application refers to software code 110, content library 112 and content delivery application 114 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media. Volatile media may include dynamic memory, such as dynamic random access memory (dynamic RAM), while non-volatile memory may include optical, magnetic, or electrostatic storage devices. Common forms of computer-readable non-transitory storage media include: internal and external hard drives, optical discs such as DVDs, RAM, programmable read-only memory (PROM), erasable PROM (EPROM), and FLASH memory.

Moreover, in some implementations, system 100 may utilize a decentralized secure digital ledger in addition to, or in place of, system memory 106. Examples of such decentralized secure digital ledgers may include a blockchain, hashgraph, directed acyclic graph (DAG), and HOLOCHAIN® ledger. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Although FIG. 1 depicts software code 110, content library 112 and content delivery application 114 as being stored together in a single instantiation of system memory 106, that representation is also provided merely as an aid to conceptual clarity. More generally, system 100 may include one or more computing platforms 102, such as computer servers, which may be co-located, or may form an interactively linked but distributed system, such as a cloud-based system. As a result, hardware processor 104 and system memory 106 may correspond to distributed processor and memory resources within system 100. Consequently, in some implementations, software code 110, content library 112 and content delivery application 114 may be stored remotely from one another on the distributed memory resources of system 100.

Hardware processor 104 may include multiple processing units, such as one or more central processing units, one or more graphics processing units and one or more tensor processing units, one or more field-programmable gate arrays (FPGAs), custom hardware for machine-learning training or inferencing, and an application programming interface (API) server. By way of definition, as used in the present application, the terms “central processing unit” (CPU), “graphics processing unit” (GPU), and “tensor processing unit” (TPU) have their customary meaning. That is to say, a CPU includes an Arithmetic Logic Unit (ALU) for carrying out the arithmetic and logical operations of computing platform 102, as well as a Control Unit (CU) for retrieving programs such as software code 110 from system memory 106, while a GPU may be implemented to reduce the processing overhead of the CPU by performing computationally intensive graphics or other processing tasks. A TPU is an application-specific integrated circuit (ASIC) configured specifically for artificial intelligence processes such as machine learning.

In some implementations, computing platform 102 may correspond to one or more web servers accessible over a packet-switched network such as the Internet. Alternatively, computing platform 102 may correspond to one or more computer servers supporting a wide area network (WAN), a local area network (LAN), or included in another type of private or limited distribution network. In addition, or alternatively, in some implementations system 100 may utilize a local area broadcast method, such as User Datagram Protocol (UDP) or BLUETOOTH®. For example, in some implementations, system 100 may be implemented in software, or as virtual machines. Moreover, in some implementations, system 100 may be configured to communicate via a high-speed network suitable for high performance computing (HPC).

Transceiver 108 of system 100 may be implemented as a wireless communication unit configured for use with one or more of a variety of wireless communication protocols. For example, transceiver 108 may include a fourth generation (4G) wireless transceiver, a 5G wireless transceiver, or both a 4G and a 5G wireless transceiver. In addition, or alternatively, transceiver 108 may be configured for communications using one or more of Wireless Fidelity (WI-FI®), Worldwide Interoperability for Microwave Access (WIMAX®), BLUETOOTH®, BLUETOOTH® Low Energy, ZIGBEE®, radio-frequency identification (RFID), near-field communication (NFC), and 60 GHz wireless communications methods.

Directional antennas 116a and 116b may be BLUETOOTH® or BLUETOOTH® Low Energy antennas, for example. In one implementation, directional antennas 116a and 116b may be included as components of an AURACAST® communication system implemented as part of system 100. Moreover, in some implementations directional antennas 116a and 116b may support bi-directional communications initiated by user 134 between personal communication device 140 and system 100, which combined with the capability of directional antennas 116a and 116b to provide the precise physical location of personal communication device 140, enables system 100 to serve the accessibility needs of user 134 more explicitly.

For example, where venue 120 is a cruise ship, airplane, or other mode of transportation, there is typically a requirement that user 134 be in a specific location during safety training, such as a life boat or life preserver drill, or an airplane evacuation drill for example. In those use cases, user 134 may be required to confirm via personal communication device 140 that user 134 has participated in the safety drill while in the area designated and understands the emergency evacuation procedures and best practices for their disability needs to fulfill the safety activity. These use cases have the dual advantages of ensuring user compliance with important safety protocols while enhancing the actual safety of the user.

Venue 120 may be an indoor venue or an outdoor venue. In various implementations, venue 120 may be a multiplex cinema including multiple theaters, a museum, a theme park, a resort property, a hotel room, a casino, a cruise ship or cruise ship cabin, an airplane, a train or rail car, or a safari vehicle, to name a few examples. In implementations in which venue 120 is a multiplex cinema, for example, predetermined area 126 of venue 120 may be a single theater within the multiplex cinema complex. Alternatively, in implementations in which venue 120 is a museum, predetermined area 126 of venue 120 may be a museum exhibit. As yet another alternative, in implementations in which venue 120 is a theme park, predetermined area 126 of venue 120 may be a segment of a theme park ride or other attraction. For example, predetermined area 126 may be a specific location on the path of a theme park ride or queue at which an interactive feature of the ride, such as an animatronic figure, speaks, gestures, or speaks and gestures to ride occupants. And so forth.

Personal communication device 140 may take the form of any suitable mobile computing device or system that implements data processing capabilities sufficient to provide a user interface, support connections to communication network 130, and implement the functionality ascribed to personal communication device 140 herein. In various implementations, personal communication device 140 may take the form of a tablet computer, smartphone, digital media player, or a wearable communication device such as a smartwatch, AR device, or VR device (e.g., headset), to name a few examples.

Content 166 may be obtained from content library 112 and may provide accessibility services including one or more of audio, video and text. Moreover, in some implementations content 166 obtained from content library 112 may be additional descriptive or interpretive material about venue 120 or predetermined area 126, technology used in venue 120 or predetermined area 126, features of a theme park attraction, or any other type of additional information desired by user 134. In addition, in some implementations system 100 may mix real-time audio output by a public address (PA) system of venue 120 with content obtained from content library 112 to produce content 166. As noted above, in some implementations content 166 may be provided at no cost, while in other implementations content 166 may be provided as premium content available to user 134 who has purchased or otherwise obtained an entitlement to such premium content.

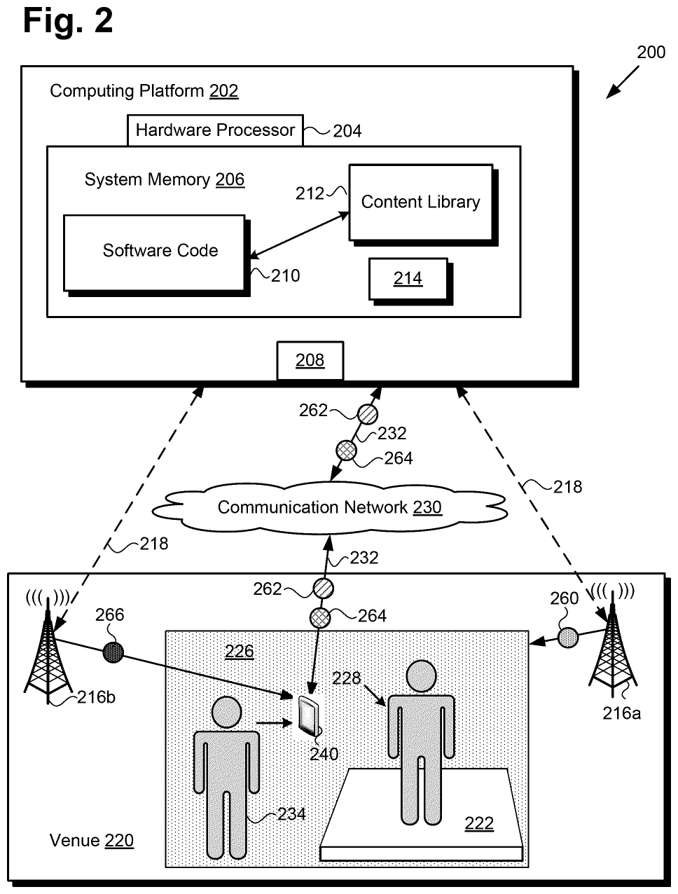

FIG. 2 shows a diagram of exemplary system 200 for providing location-based content playout, according to another implementation. System 200 includes computing platform 202 having hardware processor 204, system memory 206 implemented as a computer-readable non-transitory storage medium, and transceiver 208. According to the present exemplary implementation, system memory 206 stores software code 210, content library 212 and content delivery application 214 deployable to a variety of different types of personal communication devices. In addition, system 200 includes multiple directional antennas 216a and 216b communicatively coupled to computing platform 202 by communication links 218.

As shown in FIG. 2, system 200 is implemented within a use environment including venue 220 in which directional antennas 216a and 216b are situated, and communication network 230. As further shown in FIG. 2, venue 220 includes user 234 in attendance at event 222 in the form of a live performance or narration by performer 228, predetermined area 226 within venue 220, and personal communication device 240 utilized by user 234. Also shown in FIG. 2 are network links 232 of communication network 230 interactively connecting system 200 with personal communication device 240 of user 234, content activation signal 260 transmitted to predetermined area 226 of venue 220 by directional antenna 216a, optional request 262 for content received by system 200 from personal communication device 240 via communication network 230, optional authentication data 264 received by system 200 from personal communication device 240 via communication network 230, and content 266 optionally transmitted to personal communication device 240 by directional antenna 216b.

System 200 including multiple directional antennas 216a and 216b communicatively coupled to computing platform 202 having hardware processor 204, system memory 206 storing software code 210, content library 212 and content delivery application 214, as well as transceiver 208 corresponds in general to system 100 including multiple directional antennas 116a and 116b communicatively coupled to computing platform 102 having hardware processor 104, system memory 106 storing software code 110, content library 112 and content delivery application 114, as well as transceiver 108, in FIG. 1. Consequently, system 200, directional antennas 216a and 216b, computing platform 202, hardware processor 204, system memory 206, software code 210, content library 212, content delivery application 214 and transceiver 208, in FIG. 2, may share any of the characteristics attributed to respective system 100, directional antennas 116a and 116b, computing platform 102, hardware processor 104, system memory 106, software code 110, content library 112, content delivery application 114 and transceiver 108 by the present disclosure, and vice versa.

In addition, venue 220, predetermined area 226 within venue 220, communication links 218, communication network 230, network links 232, personal communication device 240, content activation signal 260, optional request 262 for content, optional authentication data 264 and content 266 correspond respectively in general to venue 120, predetermined area 126 within venue 120, communication links 118, communication network 130, network links 132, personal communication device 140, content activation signal 160, optional request 162 for content, optional authentication data 164 and content 166, in FIG. 1. Thus, venue 220, predetermined area 226 within venue 220, communication links 218, communication network 230, network links 232, personal communication device 240, content activation signal 260, optional request 262 for content, optional authentication data 264 and content 266 may share any of the characteristics attributed to respective venue 120, predetermined area 126 within venue 120, communication links 118, communication network 130, network links 132, personal communication device 140, content activation signal 160, optional request 162 for content, optional authentication data 164 and content 166 by the present disclosure, and vice versa.

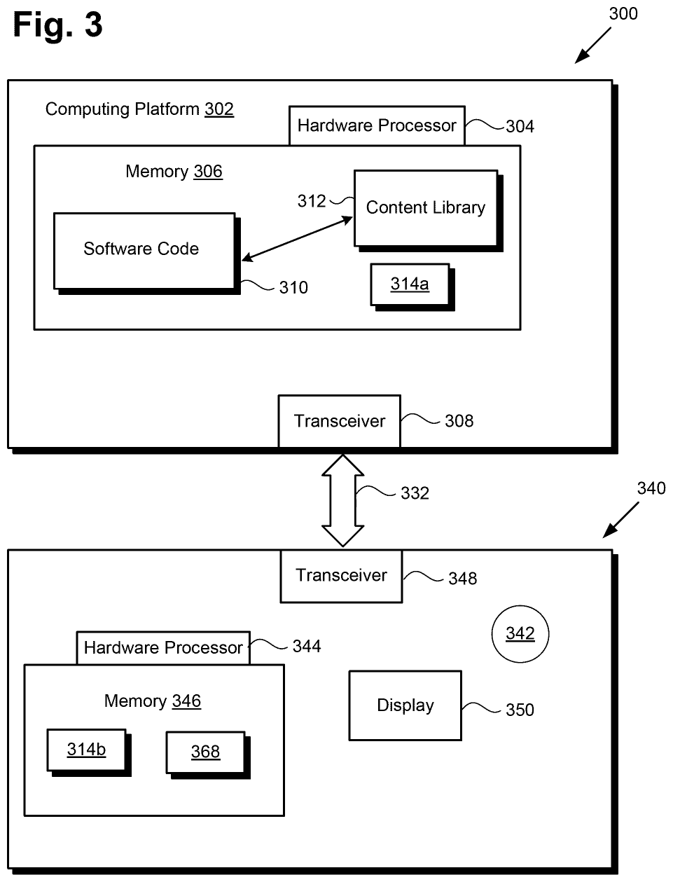

FIG. 3 shows system 300 for providing location-based content playout and a more detailed depiction of personal communication device 340 to which content delivery application 314b has been deployed, according to one implementation. Also shown in FIG. 3 is network link 332 interactively coupling system 300 and personal communication device 340. System 300 includes computing platform 302 having hardware processor 304, system memory 306 implemented as a computer-readable non-transitory storage medium, and transceiver 308. According to the present exemplary implementation, system memory 306 stores software code 310, content library 312 and content delivery application 314a deployable to a variety of different types of personal communication devices.

System 300, computing platform 302, hardware processor 304, system memory 306, software code 310, content library 312, content delivery application 314a, transceiver 308 and network link 332 correspond respectively in general to system 100, computing platform 102, hardware processor 104, system memory 106, software code 110, content library 112, content delivery application 114, transceiver 108 and network link 132, in FIG. 1. Thus, system 300, computing platform 302, hardware processor 304, system memory 306, software code 310, content library 312, content delivery application 314a, transceiver 308 and network link 332, in FIG. 3, may share any of the characteristics attributed to respective system 100, computing platform 102, hardware processor 104, system memory 106, software code 110, content library 112, content delivery application 114, transceiver 108 and network link 132 by the present disclosure, and vice versa. Consequently, although not shown in FIG. 3, like system 100, system 300 includes multiple directional antennas corresponding to directional antennas 116a and 116b communicatively coupled to computing platform 302 by communication links corresponding to communication links 118.

As shown in FIG. 3, personal communication device 340 includes hardware processor 344, audio output device 342, transceiver 348, display 350 and memory 346 implemented as a computer-readable non-transitory storage medium storing content delivery application 314b and pre-recorded content 368. It is noted that personal communication device 340 corresponds in general to personal communication 140/240 in FIGS. 1 and 2, and those corresponding features may share any of the characteristics attributed to any one of those corresponding features by the present disclosure. Thus, although not shown in FIGS. 1 and 2, personal communication device 140/240 may include features corresponding respectively to hardware processor 344, audio output device 342, transceiver 348, display 350 and memory 346 storing content delivery application 314b and pre-recorded content 368.

Hardware processor 344 may include multiple hardware processing units, such as one or more CPUs, one or more GPUs, one or more TPUs, and one or more FPGAs, as those features are defined above. Audio output device 342 may include one or more of an audio speaker integrated with personal communication device 340, headphones or earbuds in wired or wireless communication with personal communication device 340, or a device configured to drive a neck loop to enable inductive coupling to a telecoil in a hearing aid, for example.

Display 350 may take the form of a liquid crystal display (LCD), light-emitting diode (LED) display, organic light-emitting diode (OLED) display, quantum dot (QD) display, or any other suitable display screen that performs a physical transformation of signals to light. Transceiver 348 may be implemented as a wireless communication unit configured for use with one or more of a variety of wireless communication protocols. For example, transceiver 348 may include a 4G wireless transceiver, a 5G wireless transceiver, or both a 4G and 5G wireless transceiver. In addition, or alternatively, transceiver 348 may be configured for communications using one or more of WI-FI®, WIMAX®, BLUETOOTH®, BLUETOOTH® Low Energy, ZIGBEE®, RFID, NFC, and 60 GHz wireless communications methods.

Content delivery application 314b corresponds to content delivery application 314a after deployment of content delivery application 314a to personal communication device 340. For example, content delivery application 314a may be downloaded by personal communication device 340 from system 300 via network link 332, and may be persistently stored in memory 346 of personal communication device 340 as content delivery application 314b.

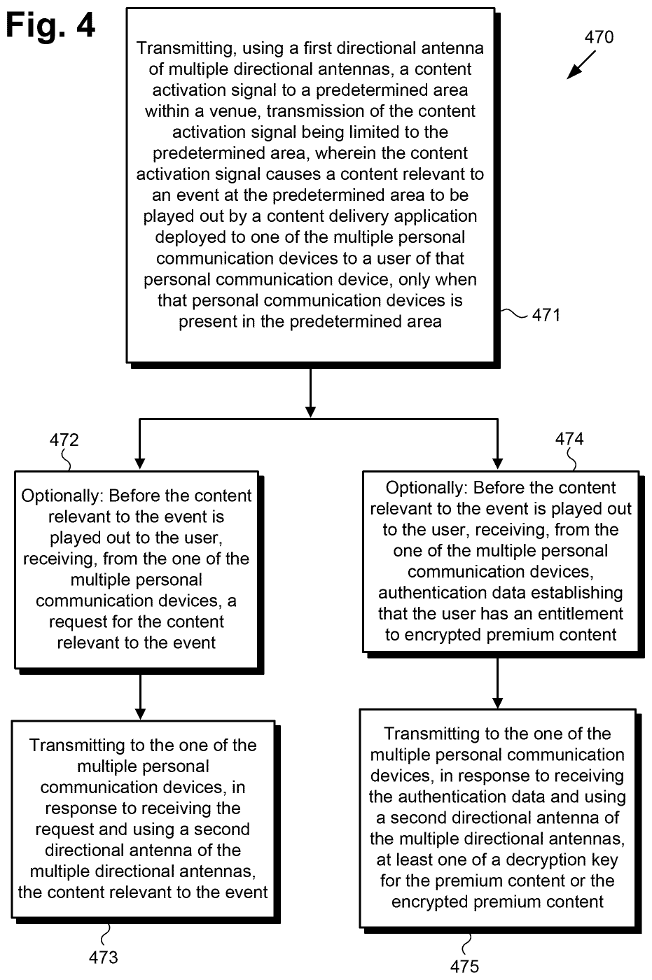

The functionality of system 100/200/300 and personal communication device 140/240/340 shown in FIGS. 1, 2 and 3 will be further described by reference to FIG. 4. FIG. 4 shows flowchart 470 presenting an exemplary method for providing location-based content playout, according to one implementation. With respect to the method outlined in FIG. 4, it is noted that certain details and features have been left out of flowchart 470 in order not to obscure the discussion of the inventive features in the present application.

Referring to FIG. 4 in combination with FIGS. 1, 2 and 3, the method outlined by flowchart 470 includes transmitting, using a first directional antenna, i.e., directional antenna 116a/216a of multiple directional antennas 116a/216a and 116b/216b, content activation signal 160/260 to predetermined area 126/226 within venue 120/220, transmission of content activation signal 160/260 being limited to predetermined area 126/226, wherein content activation signal 160/260 causes content relevant to event 122/222 at predetermined area 126/226 to be played out by content delivery application 314b deployed to personal communication device 140/240/340 to user 134/234 of personal communication device 140/240/340, only when personal communication device 140/240/340 is present in predetermined area 126/226 (action 471). Action 471 may be performed by software code 110/210/310, executed by hardware processor 104/204/304 of system 100/200/300.

As noted above, directional antenna 116a/216a may be a BLUETOOTH® or BLUETOOTH® Low Energy antenna, for example, configured to produce narrow-beamed signals in a transmission pattern resembling the output of a spotlight, rather than a conventional omnidirectional broadcast. Consequently, directional antenna 116a/216a may be used to limit transmission of content activation signal 160/260 to predetermined area 126/226, without penetration of content activation signal 160/260 into regions of venue 120/220 other than predetermined area 126/226.

Referring to FIGS. 1 and 3 in combination, in some implementations, event 122 may be a pre-recorded event, such as the screening of a feature film for example. In those implementations the content relevant to event 122 and played out to user 134 in response to content activation signal 160 may be pre-recorded content 368 relevant to event 122, obtained from content library 112/312 and may be pre-loaded onto personal communication device 140/340. In those implementations, activation signal 160 triggers playout of pre-recorded content 368 by content delivery application 314b deployed to personal communication device 140/340. Pre-recorded content 368 may provide accessibility services, and may include one or more of audio, video and text. Moreover, in some implementations pre-recorded content 368 may be additional descriptive or interpretive material about venue 120 or predetermined area 126, technology used in venue 120 or predetermined area 126, features of a theme park attraction, or any other type of additional information desired by user 134.

For example, where event 122 includes a pre-recorded performance or narration in a first language, pre-recorded content 368 relevant to event 122 may include one or more of audio describing the event in the first language or a second language with which user 134 has proficiency, text describing the event in the first language or a second language with which user 134 has proficiency, or a translation of the performance or narration into a second language with which user 134 has proficiency. Moreover, in some use cases the first language in which event 122 is performed or narrated may be a spoken language and pre-recorded content 368 may include a translation of the spoken language into a non-verbal sign language. It is noted that in use cases in which pre-recorded content 368 provides accessibility services, pre-recorded content 368 may be provided to user 134 at no cost.

In the context of a theme park ride experience, for example, predetermined area 126 may be a specific location on the path of the ride or queue for the ride at which an interactive feature of the ride, such as an animatronic figure for example, speaks, gestures, or speaks and gestures to ride occupants present at that specific location. Content activation signal 160 could be transmitted by directional antenna 116a so as to synchronize playout of pre-recorded content 368, which may provide accessibility services such as audio or captioning for example, with such interactive features. The ability by system 100/300 to accurately trigger playout of pre-recorded content 368 at a precise physical location in synchronization with elements of event 122 advantageously provides a seamless experience for a ride occupant with accessibility needs.

In some implementations, and referring to FIGS. 1, 2 and 3 in combination, it may be advantageous or desirable to provide content 166/266 relevant to event 122/222 by transmitting content 166/266 to personal communication device 140/240/340, in addition to, or in lieu of, pre-loading pre-recorded content 368 onto personal communication device 140/240/340. Referring to FIG. 4 in combination with FIGS. 1 and 2, in those implementations the method outlined by flowchart 470 may further include, before content 166/266 relevant to event 122/222 is played out to user 134/234, receiving, from personal communication device 140/240, request 162/262 for content 166/266 relevant to event 122/222 (action 472). For example, content activation signal 160/260 transmitted to predetermined area 126/226 by system 100/200 using directional antenna 116a/216a, in action 471, may identify what content is relevant to event 122/222 at predetermined area 126/226 of venue 120/220, thereby enabling personal communication device 140/240/340 to request that content.

It is noted that action 472 is optional, and may not be included in the method outlined by flowchart 470 in implementations in which pre-recorded content 368 can be relied upon exclusively to provide accessibility services or other content relevant to event 122/222. However, and referring to FIG. 2, in implementations in which event 222 includes a live performance or a live narration, pre-recorded content 368 may be insufficient, and action 472, and subsequent action 473, may be performed. In implementations in which the method outlined by flowchart 470 includes optional action 472, action 472 may be performed by software code 210, executed by hardware processor 204 of system 200, using transceiver 208 and communication network 230.

Referring to FIGS. 1, 2 and 4 in combination, in implementations in which optional action 472 is performed, the method outlined by flowchart 470 further includes transmitting to personal communication device 140/240, in response to receiving request 162/262 and using a second directional antenna, i.e., directional antenna 116b/216b of multiple directional antennas 116a/216a and 116b/216b, content 166/266 relevant to event 122/222 (action 473). Action 473 may be performed by software code 110/210/310, executed by hardware processor 104/204/304 of system 100/200/300.

As noted above, directional antenna 116b/216b may be a BLUETOOTH® or BLUETOOTH® Low Energy antenna, for example, configured to produce narrow-beamed signals in a transmission pattern resembling the output of a spotlight, rather than a conventional omnidirectional broadcast. Consequently, directional antenna 116b/216b may be used to limit transmission of content 166/266 relevant to event 122/222 to within predetermined area 126/226, without penetration of content activation signal 160/260 into regions of venue 120/220 other than predetermined area 126/226, thereby advantageously preventing crosstalk interference with other areas of venue 120/220.

Content 166/266 may provide accessibility services, and may include one or more of audio, video and text. Moreover, in some implementations content 166/266 may be additional descriptive or interpretive material about venue 120/220 or predetermined area 126/226, technology used in venue 120/220 or predetermined area 126/226, features of a theme park attraction, or any other type of additional information desired by user 134/234. In addition, in some implementations system 100/200 may mix real-time audio output by a PA system of venue 120/220 with content obtained from content library 112/212 to produce content 166/266.

In use cases in which event 122/222 includes a performance or a narration in a first language, content 166/266 relevant to event 122/222 may include one or more of audio describing the event in the first language or a second language with which user 134/234 has proficiency, text describing the event in the first language or a second language with which user 134/234 has proficiency, or a translation of the performance or narration into a second language with which user 134/234 has proficiency. Moreover, in some use cases the first language in which event 122/222 is performed or narrated may be a spoken language and content 166/266 may include a translation of the spoken language into a non-verbal sign language. It is noted that in use cases in which content 166/266 provides accessibility services, content 166/266 may be provided to user 134/234 at no cost.

In the context of a theme park ride experience, predetermined area 126/226 may be a specific location on the path of the ride or queue for the ride at which an interactive feature of the ride, such as an animatronic figure for example, speaks, gestures, or speaks and gestures to ride occupants present at that specific location. Content 166/266 could be transmitted by directional antenna 116b/216b so as to enable synchronization of playout of content 166/266, which may provide accessibility services such as audio or captioning for example, with such interactive features. The ability by system 100/200 to transmit content 166/266 to a precise physical location in synchronization with elements of event 122/222 advantageously provides a seamless experience for a ride occupant with accessibility needs.

In some implementations, and referring to FIGS. 1, 2 and 3 in combination, it may be advantageous or desirable to provide content 166/266 relevant to event 122/222, or pre-recorded content 368, as encrypted premium content reserved for users having an entitlement to that premium content. Such premium content may include interviews with a director or performer 228 associated with event 122/222, historical or cultural references related to event 122/222, or a game or other bonus content relevant to event 122/222, to name a few examples. Referring to FIG. 4 in combination with FIGS. 1, 2 and 3, in those implementations the method outlined by flowchart 470 may further include, before content 166/266 or pre-recorded content 368 is played out to user 134/234, receiving, from personal communication device 140/240/340, authentication data 164/264 establishing that user 134/234 has the entitlement to the encrypted premium content (action 474). For example, content activation signal 160/260 transmitted to predetermined area 126/226 by system 100/200 using directional antenna 116a/216a, in action 471, may identify content 166/266 or pre-recorded content 368 as encrypted premium content requiring user authentication to access.

It is noted that action 474 is optional, and may not be included in the method outlined by flowchart 470. However, in implementations in which the method outlined by flowchart 470 includes optional action 474, action 474 may be performed by software code 110/210/310, executed by hardware processor 104/204/304 of system 100/200/300, using transceiver 108/208/308 and communication network 130/230.

Referring to FIGS. 1, 2 and 4 in combination, in implementations in which optional action 474 is performed, the method outlined by flowchart 470 further includes transmitting to personal communication device 140/240, in response to receiving authentication data 164/264 and using a second directional antenna, i.e., directional antenna 116b/216b of multiple directional antennas 116a/216a and 116b/216b, at least one of a decryption key for the encrypted premium content or the encrypted premium content (action 475). Action 475 may be performed by software code 110/210, executed by hardware processor 104/204 of system 100/200.

For example, and referring to FIG. 3, in implementations in which the encrypted premium content is provided as pre-recorded content 368, only the decryption key for the encrypted premium content may be transmitted in action 475. Alternatively, and referring to FIGS. 1 and 2, in implementations in which the encrypted premium content is provided as content 166/266 transmitted to personal communication device 140/240, the encrypted premium content and the decryption key for the encrypted premium content may be transmitted in action 475.

With respect to the method outlined by flowchart 470 and described above, it is noted that action 471, or actions 471 and optional actions 472 and 473, or action 471 and optional actions 474 and 475, may be performed in an automated process from which human participation may be omitted.

Thus, the present application discloses systems and methods for providing location-based content playout that advance the state-of-the-art by providing industry standard RF communications equipment modified to include directional antenna technology in order to activate pre-recorded content stored on a personal communication device to which a content delivery application has been deployed, or to transmit content to such a device using communication technologies commonly included in consumer electronics such as smartphones. Content activation signals and content may be provided by directional antennas situated in a venue such as a theater, museum, or theme park, for example, producing narrow-beamed signals in a transmission pattern resembling the output of a spotlight, rather than a conventional omnidirectional broadcast. As noted above, these signals can be received and decoded by commercially available personal communication devices such as smartphones and wireless headphones that execute software to decode the content activation signals and the content, and playout the content to a user of the personal communication device. Multiple directional antennas capable of providing multiple digital channels of output advantageously enable users to select desired channels for their assistive, educational or entertainment needs or preferences.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a memory;
the memory storing a software code and a content delivery application deployable to a plurality of personal communication devices; and
a plurality of directional antennas communicatively coupled to the computing platform;
the hardware processor configured to execute the software code to:
transmit, using a first directional antenna of the plurality of directional antennas, a content activation signal to a predetermined area within a venue, transmission of the content activation signal being limited to the predetermined area;
wherein the content activation signal causes a content relevant to an event at the predetermined area to be played out by the content delivery application deployed to one of the plurality of personal communication devices to a user of the one of the plurality of personal communication devices, only when the one of the plurality of personal communication devices is present in the predetermined area.

2. The system of claim 1, wherein the content relevant to the event is pre-loaded on the one of the plurality of personal communication devices, and wherein the content activation signal triggers playout of the content relevant to the event.

3. The system of claim 1, wherein the event comprises a performance or a narration in a first language, and wherein the content relevant to the event includes at least one of audio describing the event, text describing the event, or a translation of the performance or narration into a second language.

4. The system of claim 3, wherein the first language is a spoken language, and wherein the second language is one of a second spoken language or a sign language.

5. The system of claim 3, wherein before the content relevant to the event is played out to the user, the hardware processor is further configured to execute the software code to:
receive, from the one of the plurality of personal communication devices, a request for the content relevant to the event; and
transmit to the one of the plurality of personal communication devices, in response to receiving the request and using a second directional antenna of the plurality of directional antennas, the content relevant to the event.

6. The system of claim 5, wherein the performance or narration is a live performance or narration.

7. The system of claim 1, wherein the content relevant to the event is encrypted premium content reserved for users having an entitlement, and wherein before the content relevant to the event is played out to the user, the hardware processor is further configured to execute the software code to:
receive, from the one of the plurality of personal communication devices, an authentication data establishing that the user has the entitlement; and
transmit to the one of the plurality of personal communication devices, in response to receiving the authentication data and using a second directional antenna of the plurality of directional antennas, at least one of a decryption key for the encrypted premium content or the encrypted premium content.

8. The system of claim 1, wherein the venue is one of: a resort property, a hotel room, a casino, a cruise ship, an airplane, a train, or a safari vehicle.

9. The system of claim 1, wherein the venue is one of: a multiplex cinema including a plurality of theaters, a museum, or a theme park, and wherein the predetermined area is one of: a single theater of the plurality of theaters, a museum exhibit, or a segment of a theme park ride or queue.

10. The system of claim 1, wherein the plurality of directional antennas comprise at least one of Bluetooth antennas or Bluetooth Low Energy antennas.

11. The system of claim 1, wherein the predetermined area is a specific location on a path of a theme park ride or a queue for the theme park ride, and wherein the content relevant to the event is played out to the user in synchronization with an action by an interactive feature of the theme park ride at the specific location.

12. A method for use by a system including a hardware processor, a memory storing a software code and a content delivery application deployable to a plurality of personal communication devices, and a plurality of directional antennas communicatively coupled to the computing platform, the method comprising:
transmitting, by the software code executed by the hardware processor and using a first directional antenna of the plurality of directional antennas, a content activation signal to a predetermined area within a venue, transmission of the content activation signal being limited to the predetermined area;
wherein the content activation signal causes a content relevant to an event at the predetermined area to be played out by the content delivery application deployed to one of the plurality of personal communication devices to a user of the one of the plurality of personal communication devices, only when the one of the plurality of personal communication devices is present in the predetermined area.

13. The method of claim 12, wherein the content relevant to the event is pre-loaded on the one of the plurality of personal communication devices, and wherein the content activation signal triggers playout of the content relevant to the event.

14. The method of claim 12, wherein the event comprises a performance or a narration in a first language, and wherein the content relevant to the event includes at least one of audio describing the event, text describing the event, or a translation of the performance or narration into a second language.

15. The method of claim 14, wherein the first language is a spoken language, and wherein the second language is one of a second spoken language or a sign language.

16. The method of claim 14, further comprising:
before the content relevant to the event is played out to the user, receiving from the one of the plurality of personal communication devices, by the software code executed by the hardware processor, a request for the content relevant to the event; and
transmitting to the one of the plurality of personal communication devices, by the software code executed by the hardware processor in response to receiving the request and using a second directional antenna of the plurality of directional antennas, the content relevant to the event.

17. The method of claim 16, wherein the performance or narration is a live performance or narration.

18. The method of claim 12, wherein the content relevant to the event is encrypted premium content reserved for users having an entitlement, the method further comprising:
before the content relevant to the event is played out to the user, receiving from the one of the plurality of personal communication devices, by the software code executed by the hardware processor, an authentication data establishing that the user has the entitlement; and
transmitting to the one of the plurality of personal communication devices, by the software code executed by the hardware processor in response to receiving the authentication data and using a second directional antenna of the plurality of directional antennas, at least one of a decryption key for the encrypted premium content or the encrypted premium content.

19. The method of claim 12, wherein the venue is one of: a resort property, a hotel room, a casino, a cruise ship, an airplane, a train, or a safari vehicle.

20. The method of claim 19, wherein the venue is one of: a multiplex cinema including a plurality of theaters, a museum, or a theme park, and wherein the predetermined area is one of: a single theater of the plurality of theaters, a museum exhibit, or a segment of a theme park ride or queue.

21. The method of claim 12, wherein the plurality of directional antennas comprise at least one of Bluetooth antennas or Bluetooth Low Energy antennas.

22. The method of claim 12, wherein the predetermined area is a specific location on a path of a theme park ride or a queue for the theme park ride, and wherein the content relevant to the event is played out to the user in synchronization with an action by an interactive feature of the theme park ride at the specific location.
